(19) United States
(12) Patent Application Publication
(10) Pub. No.: US 2009/0032315 A1
(43) Pub. Date: Feb. 5, 2009

(54) Systems for Powering Vehicles using Compressed Air and Vehicles Involving Such Systems

(76) Inventor: David Porter, Covington, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/951,640

(22) Filed: Dec. 6, 2007

Related U.S. Application Data
(60) Provisional application No. 60/953,823, filed on Aug. 3, 2007.

(51) Int. Cl. B60K 3/02; F01B 17/02

(52) U.S. Cl. 180/54.1; 91/188; 91/3

(57) ABSTRACT

Systems for powering vehicles using compressed air and vehicles involving such systems are provided. In this regard, a representative system includes: a power source configured to power an air compression system, the air compression system comprising at least one air compressing piston; a compressed air storage system, comprising at least two storage tanks configured to store compressed air from the air compression system; a valve configured to control release of air from the compressed air storage system into a rotor system; the rotor system comprising a first air jet configured to direct the released air into a plurality of paddles located about a circumference of at least one rotor, thereby turning the at least one rotor.

### CROSS REFERENCES TO RELATED APPLICATIONS

The present patent application claims priority to U.S. Provisional Application 60/953,823, entitled “Comprehensive Compressed Air Rotary Drive System for Most Vehicles”, filed Aug. 3, 2007, which is incorporated by reference herein.

### BACKGROUND

1. Technical Field

The disclosure generally relates to vehicle power systems.

2. Description of the Related Art

Vehicular travel is the backbone of life in the modern world. The problem of how to efficiently and cleanly power vehicles for the transport of people and goods is one of the most important questions facing society today. Most vehicle engines are powered by petroleum-derived fuels. Petroleum is a limited resource, and can be highly polluting to the environment. Ethanol and other alternative fuels may be an improvement over petroleum-derived fuels in some respects, but have other attendant issues such as a lack of available refueling stations.

### SUMMARY

Systems for powering vehicles using compressed air and vehicles involving such systems are provided. In this regard, a first exemplary embodiment of a system for powering a vehicle using compressed air comprises: a power source configured to power an air compression system, the air compression system comprising at least one air compressing piston; a compressed air storage system, comprising at least two storage tanks configured to store compressed air from the air compression system; a valve configured to control release of air from the compressed air storage system into a rotor system; the rotor system comprising a first air jet configured to direct the released air into a plurality of paddles located about a circumference of at least one rotor, thereby turning the at least one rotor.

A second exemplary embodiment of a system for powering a vehicle using compressed air comprises: three rotors having paddles located about the respective rotor circumferences, the radius at which the paddles are located on the first rotor being larger than the radius at which the paddles are located on the second rotor, and the radius at which the paddles are located on the second rotor being larger than the radius at which the paddles are located on the third rotor, the three rotors rotating together about a shaft; an air jet configured to direct compressed air into the paddles located about the circumference of the rotors, thereby turning the rotors in a rotational direction, the air jet being directed at the first rotor during a first range of rotations per minute (RPMs), being directed at the second rotor during a second range of rotations per minute, and being directed at the third rotor during a third range of rotations per minute; wherein the first range is smaller than the second range, and the second range is smaller than the third range.

A third exemplary embodiment of a system for powering a vehicle using compressed air comprises: a power source configured to power at least one air compressing piston; at least two compressed air storage tanks configured to store compressed air from the at least one air compressing piston; a multi-rotor system having paddles located about respective rotor circumferences, the radius at which the paddles are located on a first rotor being larger than the radius at which the paddles are located on a second rotor, the rotors rotating together about a shaft; a first air jet configured to direct compressed air into the paddles located about the circumferences of the three rotors, thereby turning the rotors and the shaft in a rotational direction; an air release regulator valve coupled to an accelerator pedal of a vehicle, the air release regulator valve being positioned between the compressed air storage system and the air jet, the air release regulator valve configured to control the speed of the automobile; and the shaft configured to power a driveshaft of the automobile, the driveshaft further configured to turn at least a wheel of the automobile.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale. Moreover, in the drawings, like reference numerals designate corresponding parts throughout the several views.

FIG. 1 shows schematic diagram of a vehicle with a compressed air vehicle drive system for powering the vehicle.

FIG. 2 is a cross-sectional view of an embodiment of an air compression system.

FIG. 3 is a cross-sectional view of a second embodiment of an air compression system.

FIG. 4 is a detailed view of an embodiment of a compressed air storage system.

FIG. 5 is a detailed view of an embodiment of a rotor system.

FIG. 6 is a side view of an embodiment of a rotor, reverse jet, air brake, and housing.

FIG. 7 is a side view of an embodiment of a rotor and housing.

FIG. 8 is a cross-sectional view of an embodiment of a rotor with a compression drive housing.

FIG. 8A is an enlarged view of an embodiment of a compression drive housing

FIG. 9 shows a view of an embodiment of a compression drive housing.

FIGS. 10A-10D show additional views of an embodiment of a compression drive housing.

FIG. 11 shows a front view of an exemplary cross section of rotor housing placement on a base.

FIG. 12 shows exemplary placement of synthetic oil-soaked material on an embodiment of a rotor.

### DETAILED DESCRIPTION

Systems for powering vehicles using compressed air and vehicles involving such systems are provided, several exemplary embodiments of which will be described in detail. Embodiments of the drive system may be non-polluting and energy efficient, and could be used easily within the framework of current infrastructure. In some embodiments, the compressed air used to produce the power may be compressed using solar power, which is an abundant, free resource, and the only exhaust from the drive system may be filtered air.

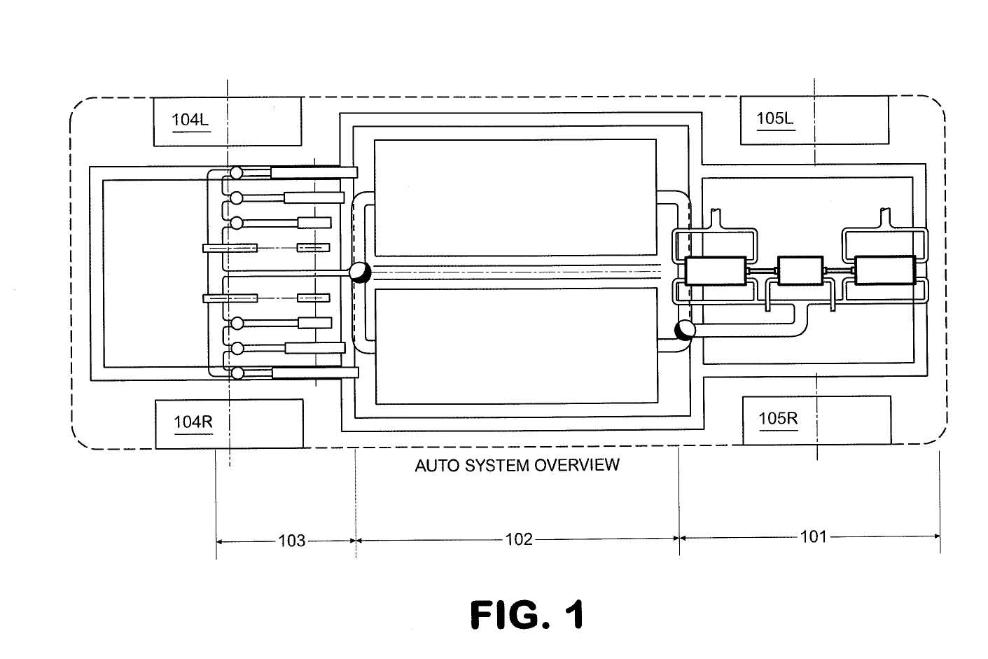

FIG. 1 schematically depicts a vehicle (e.g., an automobile) that includes front wheels 105L and 105R, rear wheels 104L and 104R, and an embodiment of a compressed air powered drive system. At the front of the automobile is an air compression system 101, which provides compressed air into compressed air storage system 102. The storage system 102 in turn powers a rotor system 103, which rotates the rear wheels 104L and 104R of the automobile, thereby propelling the automobile.

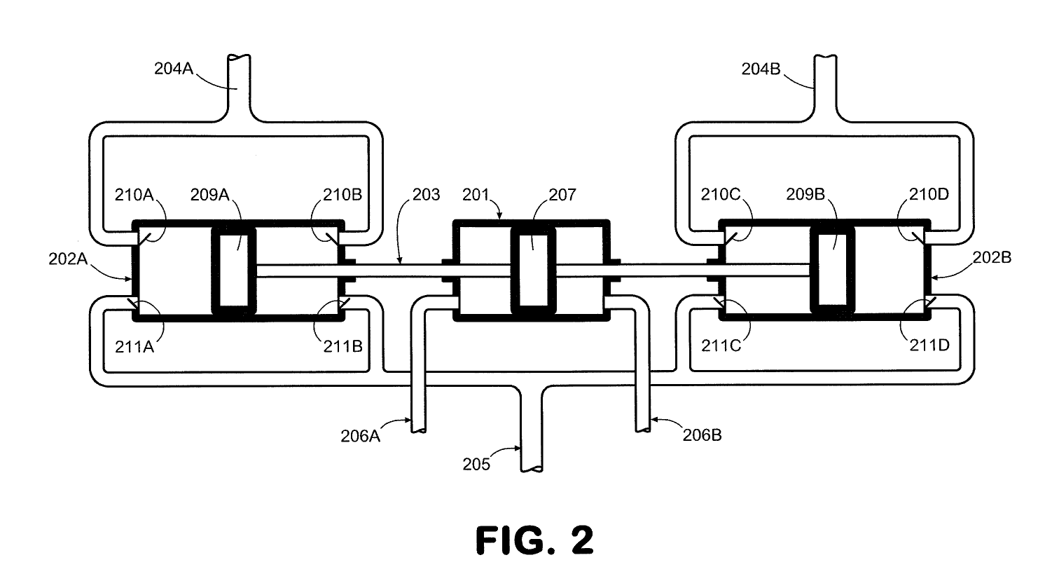

FIG. 2 depicts an exemplary embodiment of an air compression system that may be used in the system of FIG. 1. The air compression system comprises a cylindrical hydraulic piston housing 201, which is connected to two cylindrical pneumatic piston housings 202A and 202B via piston rod 203. The cylindrical pneumatic piston housings 202A and 202B have filtered air intakes 204A and 204B, respectively, and are connected to air output 205, which connects to the compressed air storage system. The piston 207 contained in housing 201 is powered by a hydraulic pump (not shown) via hydraulic hoses 206A and 206B. In some embodiments, the hydraulic pump may be powered by at least two banks of 12-volt batteries; one bank may be in use while the other is being recharged by, for example, a solar power or generator system located at an appropriate place in the vehicle. The piston 207 thereby actuates piston rod 203, which powers pneumatic pistons 209A and 209B within pneumatic piston housings 202A and 202B. The pistons 207, 209A, and 209B, and rod 203 work together as one moving piece in a linear reciprocating motion. Air flows from air intakes 204A and 204B through one-way entrance valves 210A, 210B, 210C and 210D into piston housings 202A and 202B, where the air is compressed by the motion of pistons 209A and 209B. Compressed air then leaves piston housings 202A and 202B via one-way exit valves 211A, 211B, 211C and 211D to air output 205, which connects to the compressed air storage system. The pistons 209A and 209B are double-acting pistons that deliver compressed air on both strokes of the piston.

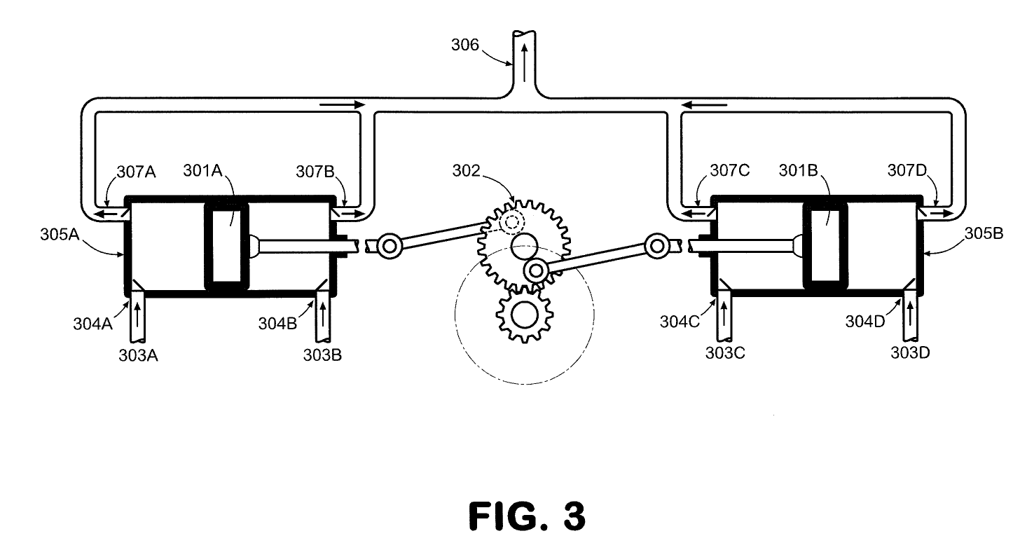

FIG. 3 shows an alternative embodiment of an air compression system. In this embodiment, double-acting pistons 301A and 301B, housed in piston housings 305A and 305B, respectively, are powered by a heavy-duty electric motor 302. Motor 302 may be geared down for power. Air enters the system at intakes 303A, 303B, 303C, and 303D via one-way entrance valves 304A, 304B, 304C, and 304D. The air is then compressed within the piston housings 305A and 305B by pistons 301A and 301B, and sent to the compressed air storage system through one-way exit valves 307A, 307B, 307D, and 307D via compressed air output 306. The forgoing examples are not limiting; any appropriate mechanism may be used to actuate the pistons that compress the air, and any appropriate number of air compressing pistons may be used.

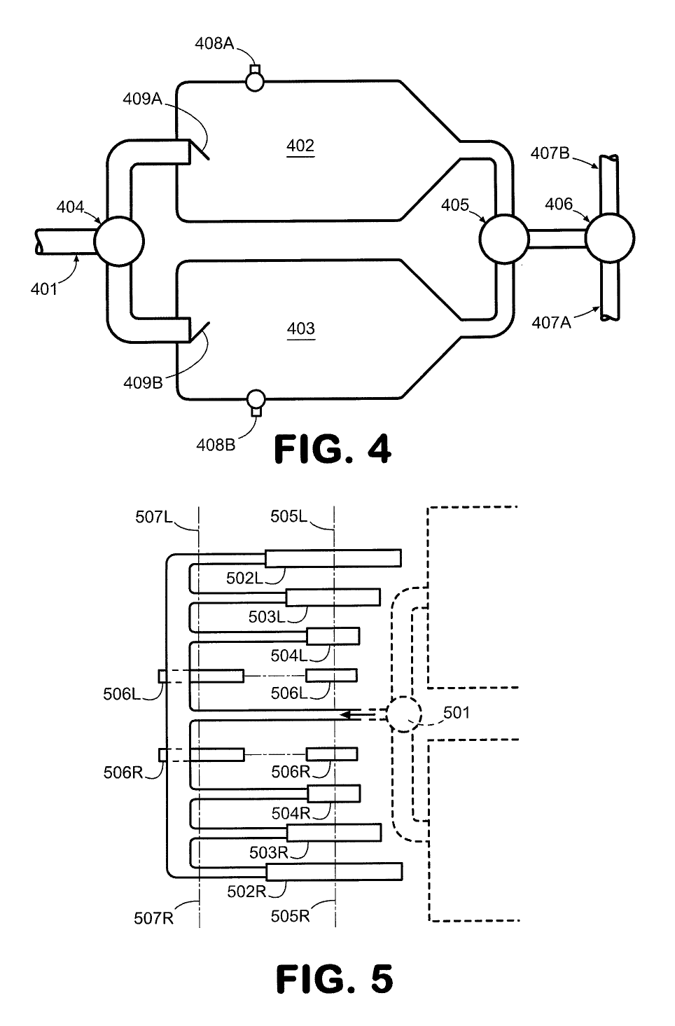

An embodiment of a compressed air storage system is shown in FIG. 4. The system comprises storage tanks 402 and 403, which are coupled to intake control valve 404, release valve 405, and air regulator valve 406. The tanks include optional air pressure release valves 408A and 408B for regulating the air pressure within the tanks. Compressed air travels to the storage tanks 402 and 403 via piping 401. The airflow is directed to fill either tank 402 or 403 by an intake control valve 404, which is an electronically controlled directional valve in this embodiment that is configured to allow only one of the tanks to fill at any given time. The air enters the tanks via one-way entrance valves 409A and 409B. Airflow out of the tanks is controlled by release valve 405. The release valve 405 may be electronically controlled to allow only one tank to release air at a time. The drive system releases air from a first full tank 402 until the first tank 402 is depleted, at which point the release valve 405 will switch over to second tank 403, which may have been refilled by the air compression system 101 while the first tank 402 released air. Then, while tank 403 releases air into the system, tank 402 is refilled. When both tanks are full the air compressor system does not need to run. In some embodiments there may be more than two air storage tanks, depending on the configuration of the drive system. After passing through valve 405, the air is directed to the rotors by air release regulator valve 406. Valve 406 may be spring-loaded and may be connected to the accelerator pedal of the automobile, to control the airflow and thereby control the speed of the vehicle. When the accelerator pedal is pressed the valve 406 opens releasing controlled amounts of air to the rotor system through piping 407A and 407B. The forgoing example is not limiting; more than two air tanks may be used if desired.

An exemplary layout of the rotor system is shown in FIG. 5. The system comprises three pairs of rotors, 502L and 502R, 503L and 503R, and 504L and 504R, with a set of three rotors being associated with each wheel 104L and 104R, and with power shafts 505L and 505R, respectively. The rotors rotate with power shafts 505L and 505R. The compressed air travels through piping 501 from valve 406 to the rotors. The largest diameter rotors 502L and 502R create the most torque and power, and are used for startup, low speeds, reverse, and airbrake. Medium-sized rotors 503L and 503R are used for intermediate speeds. Rotors 504L and 504R are the smallest of the rotors, used for maximum speeds. In an exemplary form of operation, when rotors 502L and 502R achieve maximum rotations per minute (rpm), airflow is switched to rotors 503L and 503R. When rotors 503L and 503R in turn achieve maximum rpm, airflow is switched to rotors 504L and 504R. Only one matched pair of rotors is powered by the airflow at any given time. The power from rotors 502L and 502R, 503L and 503R, and 504L and 504R is transferred to power shafts 505L and 505R, which is coupled via mechanisms 506L and 506R to the driveshafts 507L and 507R. The driveshafts 507L and 507R turns the wheels 104L and 104R, respectively, of the vehicle.

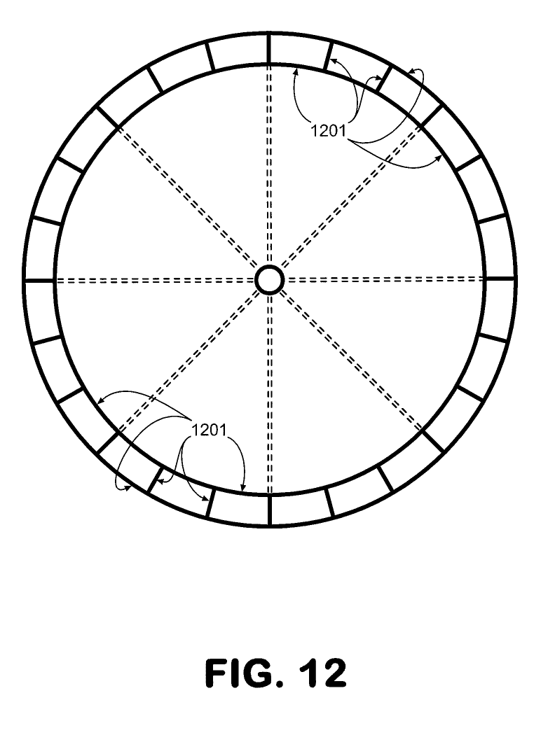

FIG. 6 shows an embodiment of the largest rotors 502L and 502R. The rotor 606 has paddles situated at continuous intervals about its circumference, similar to the paddles on a waterwheel. The air jet or nozzle 601 forces air at a high velocity into the paddles 602 on the circumference of the rotor 606, causing rotational movement of the rotor about power shaft 608. Used air is released via output 603. Additional air jets may be directed at the paddles 602 of rotor 606, such as a reverse jet 604 and airbrake 605. Jets 604 and 605 push rotor 606 in the opposite direction as jet 601, to either slow or reverse the movement of the rotor. This allows the vehicle to be backed up, or assists the mechanical brakes in stopping the automobile so that it may be stopped faster than using the mechanical brakes alone. In one embodiment, the air brake is engaged at vehicle speeds of over 35 miles per hour. Rotor 606 may include an oil-soaked synthetic material placed around the rotor in the paddles and on all surfaces where near contact occurs, to stop the leakage of air and thereby make the drive system more efficient. An exemplary placement of this material is shown in FIG. 12, element 1201.

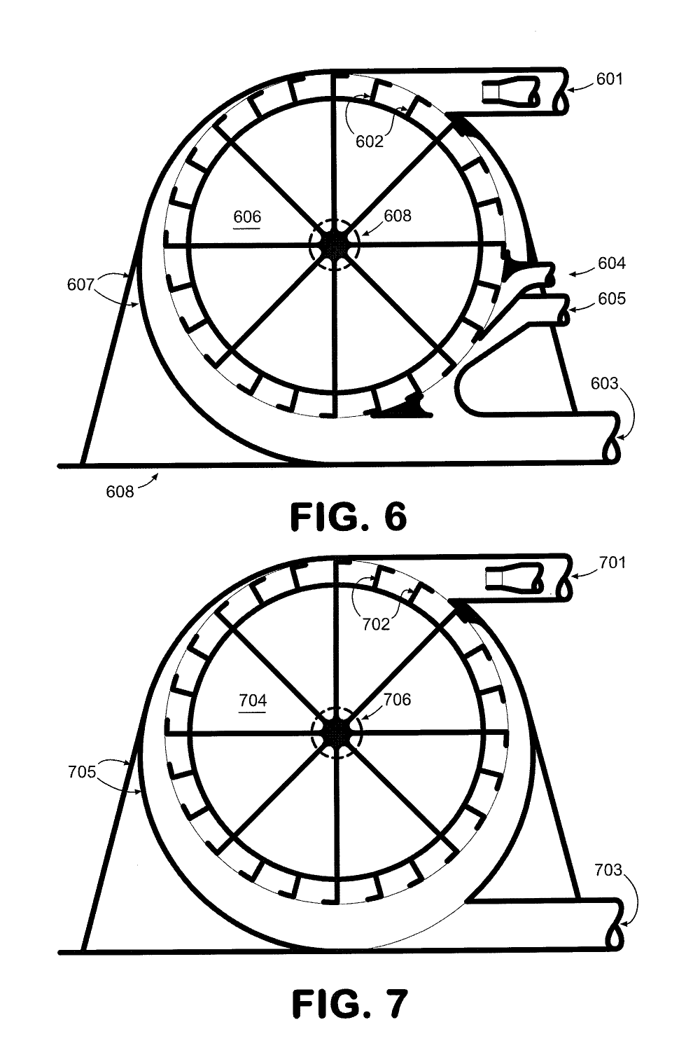

An embodiment of the smaller rotors 503L and 503R, and 504L and 504R, is shown in FIG. 7. The rotor has paddles situated at continuous intervals about its circumference, similar to the paddles on a waterwheel. Air jet or nozzle 701 directs compressed air into paddles 702 on the circumference of the rotor 704, causing rotational motion of the rotor about power shaft 706, and the used air is released via output 703. This embodiment of the smaller rotors is for forward propulsion only, and does not have a brake. Rotor 704 may include an oil-soaked synthetic material placed around the rotor in the paddles and on all surfaces where near contact occurs, to stop the leakage of air and thereby make the drive system more efficient. An exemplary placement of this material is shown in FIG. 10, element 1001.

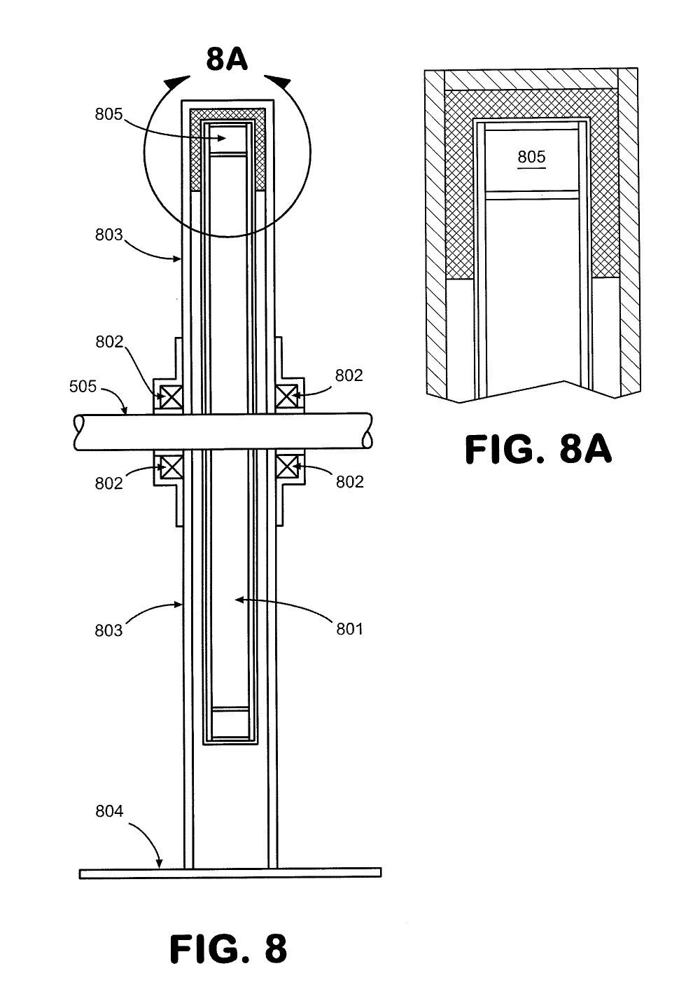

FIG. 8 shows a cross-section through an example rotor of FIG. 7. Rotor 801 rotates about bearing 802, which turns power shaft 505. The rotor 801 is contained in housing 803, which is mounted on base 804. The efficiency of the rotor is further enhanced by the compression drive chamber 805, which is shown in an enlarged view in FIG. 8A.

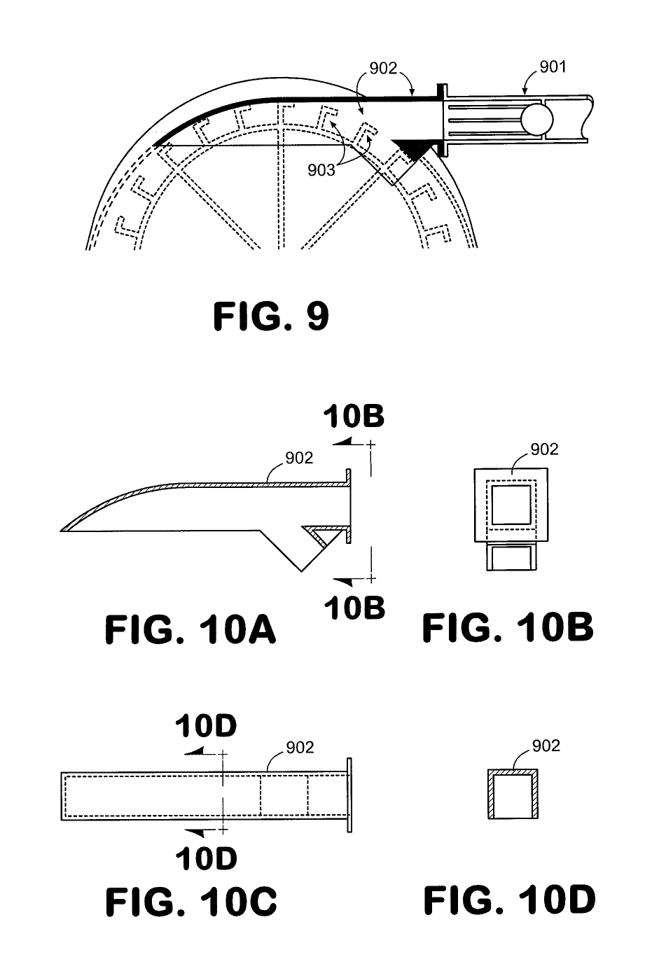

FIGS. 9 and 10 show detailed views of an embodiment of compression drive chamber 805 of FIG. 8A; the drive chamber 805 increases air tolerances and reduces drag through the use of tightly controlled tolerances. The compression drive chamber also reduces the surface area contact between the rotor and other surfaces, thereby reducing air loss and making the rotor system more efficient. A synthetic oil soaked material strip is placed around the rotor on all surfaces where contact occurs to reduce air loss, as shown by locations 1201 in FIG. 12. Referring to FIG. 9, the air jet assembly 901 directs compressed air into the compression drive housing 902, causing the paddles 903 to turn the rotor. FIG. 10A shows a side cross section of the compression drive housing 902, and FIG. 10B shows a front view of FIG. 10A as viewed along section line 10B-10B. FIG. 10C shows a top view of the compression drive housing 902, and FIG. 10D shows a cross section of FIG. 10C as viewed along section line 10D-10D. There is a compression drive chamber on each rotor; notably, there is an additional compression drive chamber located at the reverse/air brake jets 604 and 605 on the large rotor 606 of FIG. 6. All the air that passes through the compression drive chambers is used to create rotational energy and power in the rotors.

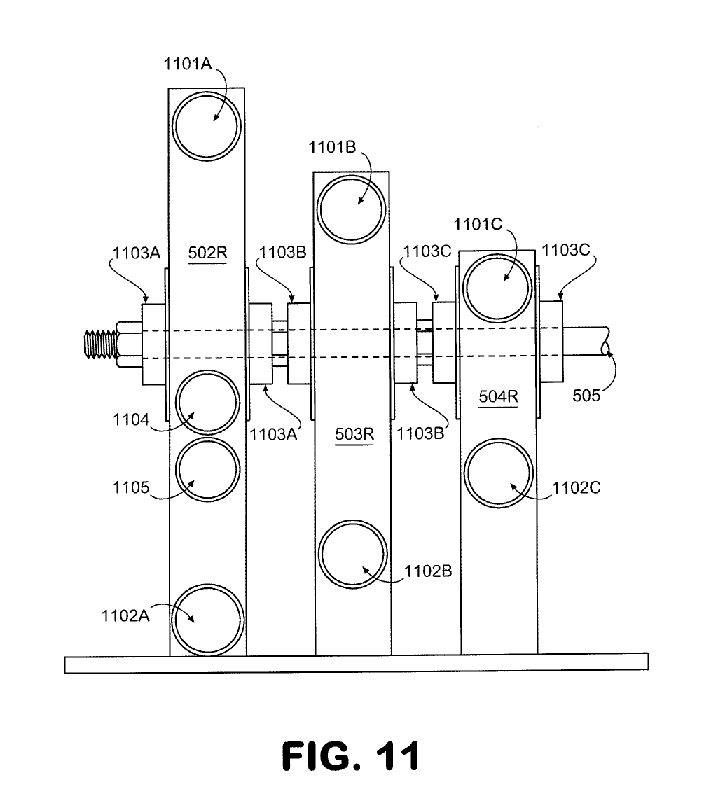

FIG. 11 shows in detail the locations of the air intake jets and exhaust ports of the right-hand side of the rotor system of FIG. 5. Intake jets 1101A, 1101B, and 1101C power rotors 502R, 503R, and 504R. Used air exhausts to ports 1102A, 1102B, and 1102C. The rotors 502R, 503R, and 504R rotate about bearing housings 1103A, 1103B, and 1103C, respectively, which rotates power shaft 505. Reverse air intake 1104 and air brake intake 1105 function to slow and reverse the motion of rotor 502R. Rotors 502L, 503L, and 504L operate in the same manner as the right side of the rotor system.

The rotors 502L, 502R, 503L, 503R, 504L, and 504R are similar in structure, size being the main notable difference. In the above embodiments, three rotors per wheel is merely used as an example; it is within the contemplation of the present disclosure to include either more or less rotors, depending on the type of vehicle being powered. In another embodiment, the disclosed drive system may power a 4-wheel-drive automobile. To achieve this, two large rotors of the type of 502L and 502R may be used to power the front wheels 105L and 105R of the automobile of FIG. 1. A rotor system may also be used to turn a propeller, powering aircraft or water-going vehicles.

The compressed air drive system contemplated by the present disclosure may be energy efficient and non-polluting. In some embodiments, the only exhaust is filtered air. Embodiments that utilize solar power stored in battery banks to power the air compressor may be operated virtually for free, and would not require stops at refueling stations. Various embodiments may be used to power such diverse types of vehicles as automobiles, trucks, tractor-trailers, trains, propeller-driven aircraft, heavy equipment, boats, ships, ATVs, water vehicles, or snowmobiles; the list of possible applications is not exhaustive.

It should be emphasized that the above-described embodiments are merely possible examples of implementations set forth for a clear understanding of the principles of this disclosure. Many variations and modifications may be made to the above-described embodiments without departing substantially from the spirit and principles of the disclosure. All such modifications and variations are intended to be included herein within the scope of this disclosure and protected by the accompanying claims.

1. A compressed air powered vehicle drive system comprising:
a power source configured to power an air compression system, the air compression system comprising at least one air compressing piston;
a compressed air storage system, comprising at least two storage tanks configured to store compressed air from the air compression system;
a valve configured to control release of air from the compressed air storage system into a rotor system;
the rotor system comprising a first air jet configured to direct the released air into a plurality of paddles located about a circumference of at least one rotor, thereby turning the at least one rotor.

2. The system of claim 1, further comprising a second air jet configured to turn the at least one rotor in an opposite rotational direction to that of the first air jet.

3. The system of claim 1, wherein the rotor system is associated with a rear wheel of an automobile.

4. The system of claim 1, further comprising an accelerator pedal of a vehicle coupled to the valve, such that the positioning of the pedal controls the valve to control the release of air to the first air jet.

5. The system of claim 1, wherein the air compressing piston is a double-acting piston configured to deliver compressed air to one of the storage tanks on each stroke of the piston.

6. The system of claim 1, wherein the rotor system further comprises a multi-rotor system having paddles located about respective rotor circumferences, a radius at which the paddles are located on a first rotor of the multi-rotor system being larger than a radius at which the paddles are located on a second rotor of the multi-rotor system.

7. A compressed air powered rotor system comprising:
three rotors having paddles located about the respective rotor circumferences, the radius at which the paddles are located on the first rotor being larger than the radius at which the paddles are located on the second rotor, and the radius at which the paddles are located on the second rotor being larger than the radius at which the paddles are located on the third rotor, the three rotors rotating together about a shaft;
an air jet configured to direct compressed air into the paddles located about the circumference of the rotors, thereby turning the rotors in a rotational direction, the air jet being directed at the first rotor during a first range of rotations per minute (RPMs), being directed at the second rotor during a second range of rotations per minute, and being directed at the third rotor during a third range of rotations per minute;
wherein the first range is smaller than the second range, and the second range is smaller than the third range.

8. The system of claim 7, further comprising a second air jet configured to turn the first rotor in an opposite rotational direction to that of the first air jet.

9. The system of claim 7, wherein the paddles are lined with oil soaked synthetic material.

10. The system of claim 7, wherein:
the air jet is powered by a compressed air storage system comprising at least two compressed air tanks; and
the air is released from only one of the compressed air tanks to the air jet at any given time.

11. The system of claim 10, further comprising an air release regulator valve configured to control the release of air from the compressed air storage system, the air release regulator valve being coupled to an accelerator pedal such that the positioning of the pedal controls the air release regulator valve to control the release of air to the first air jet.

12. A compressed air powered vehicle drive system for propelling an automobile, comprising:
a power source configured to power at least one air compressing piston;
at least two compressed air storage tanks configured to store compressed air from the at least one air compressing piston;
a multi-rotor system having a first rotor, a second rotor, and paddles located about respective rotor circumferences, the radius at which the paddles are located on the first rotor being larger than the radius at which the paddles are located on the second rotor, the rotors rotating together about a shaft;
a first air jet configured to direct compressed air into the paddles located about the circumferences of the three rotors, thereby turning the rotors and the shaft in a rotational direction; and
an air release regulator valve positioned between the compressed air storage system and the air jet, the air release regulator valve being configured to control speed of the automobile;
the shaft being configured to power the automobile.

13. The system of claim 12, wherein:
the first air jet is configured to direct compressed air into the paddles of the first rotor during a first range of rotations per minute and into the paddles of the second rotor during a second range of rotations per minute; and
the first range is smaller than the second range.

14. The system of claim 12, further comprising a second air jet configured to turn the first rotor in the opposite direction as the first air jet such that the second air jet slows the speed of the automobile.

15. The system of claim 14, further comprising a third air jet configured to turn the first rotor in the opposite direction as the first air jet such that the third air jet propels the automobile backwards.

16. The system of claim 12, wherein one of the compressed air storage tanks releases compressed air to the air jet while another of the compressed air storage tanks is refilled with compressed air from the air compressing piston.

17. The system of claim 12, wherein:
the multi-rotor system is a first multi-rotor system;
the system further comprises a second multi-rotor system; and
a first wheel of the automobile is associated with the first multi-rotor system and a second wheel of the automobile is associated with the second multi-rotor system.

18. The system of claim 17, further comprising a single rotor and air jet system configured to operate the automobile in a four-wheel-drive mode.

19. The system of claim 12, wherein the at least one air compressing piston is a double-acting piston configured to deliver compressed air to a corresponding one of the compressed air storage tanks on each stroke of the piston.

20. The system of claim 12, wherein the air release regulator valve is coupled to an accelerator pedal such that the positioning of the pedal controls the air release regulator valve to control the release of air to the first air jet.
